(19) United States
(12) Patent Application Publication
(10) Pub. No.: US 2009/0285688 A1
(43) Pub. Date: Nov. 19, 2009

(54) Double wind turbine

(76) Inventor: Israel Ortiz, Guayama, PR (US)

Correspondence Address: Israel Ortiz, P.O. Box 1326, Guayama, PR, 00785, US

(21) Appl. No.: 12/152,908

(22) Filed: May 19, 2008

(51) Int. Cl. F03D 3/06

(52) U.S. Cl. 416/197 A; 416/204 R

(57) ABSTRACT

This turbine is really two turbines in one. One turbine inside the other. The outer turbine is compose of vanes parallel to the axis of rotation This outer turbine will rotate because the left side is always opened to the wind, because of the 45 degrees that the vanes have with respect to the diameter of the outer turbine and will interact with the wind. On the right side the vanes are overlapping and will have little interaction with the wind. The inner turbine composed of vertical vanes will rotate because on the left side the wind is entering the turbine and pushing the inner turbine as it turns away from the wind. On the right side the inner turbine is turning into the wind, but it is being shield by the overlapping effect of outer turbine's vanes. This interaction of the two turbines will increase the overall efficiency of this turbine.

### FIELD OF THE INVENTION

The present invention relates to vertical axle wind turbine, but more particularly, to vertical axis omni-directional wind turbines, that is immune to turbulence.

### BACKGROUND OF THE INVENTION

As is well know today, the fossil fuel is reaching a point where it will not supply the world's energy needs in the near future, this is because the oil wells are drying up all over the planet. That is why the oil price goes up and it is more difficult to find new oil wells. Also it is well known that the planet is warming up and this is a real threat to life, included mankind. There for a lot of research is going on to find new none pollution forms of energy sources. One of them being the wind which is always free and is totally none polluted.

One way to catch this wind energy is to use horizontal axis wind turbine, which have to be mounted on top of high towers, out at sea or on a high mountain.

Horizontal axis turbines have to operate high on top of a tower because the wind has less turbulence and they can't cope with turbulence. Also they have the electrical generators and gear boxes high on top of the towers. This kind of turbine needs a mechanical or electronic control to maintain it pointing into the wind for the proper function of this device. Also it needs a control device to adjust the pitch of the blade for different wind speeds. Because of this the tower has to be build of strong structure, making the construction and maintenance very costly. These turbines are not well suited to function at tree tops or on top of a house or building because of the already been said.

It is therefore an object of the invention to produce motive force from the wind which can be converted to electrical power.

It is another object of this invention to have a high degree of efficiency at heavy loads because of the interaction between the inner and outer turbines that make up this turbine.

It is another object of the invention to be able to work at tree top level and also, at tower level, although a tower is not really needed.

It is another object of the invention to produce power output even under intense wind turbulence.

It is another object of the invention to work at tree top or on top of a house, without the need of a tower because this turbine is immune to turbulence.

It is another object of the invention to be more efficient at low wind speeds, because of the inner turbine and outer turbine combination that make up this turbine.

It is another object of this invention to make it easier to maintain because it works at tree top, not on a tower.

### SUMMARY OF THE INVENTION

This turbine is vertical axis wind turbine. The vanes run parallel to the axis of rotation, and with two turbines one inside the other rotating in the same direction. The outer turbine is a turbine on its own. It can produce motive force from the wind with no outside help. It is made of vanes that run parallel to the axis of rotation in a circular configuration and the vanes are at 45 degrees with reference to the radius of the circumference of the turbine. With this angle the outer turbine will turn because on the side that is moving away from the wind the vanes are open and will interact with the wind. On the side that is moving into the wind the vanes are close and overlapping presenting very little interaction or resistance to the wind, causing a spinning motion. Also on the back side of the turbine where the wind is exiting, the wind will cause a rotation in the same direction as where the wind is entering because of the angle of 45 degrees of the vanes with respect to the radius of the turbine. The inner turbine uses the shielding effect of the outer turbine to increase its torque. This is so because the outer turbine is always is letting the wind hit the inner turbine when it is moving away from the wind, and shielding it when moving into the wind. This interaction between the two turbines will cause a greater torque at low wind speed or heavy loads. It also will solve the problem of early vertical turbines that will not spin because of cancellation of torque. This turbine is omni-directional and can operate at low altitude, no need of a tower. It will not be affected by wind turbulence. No matter what direction the wind is coming from, the top, the bottom or 360 degrees around the turbine it will spend in the same direction. It can operate at greater wind speed variations. The generator will be at ground level.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a front perspective view of the turbine, showing the arrangement of both the inner turbine and outer turbine;

FIG. 2 is a front view of the turbine;

FIG. 3 is a top plan view of the turbine;

FIG. 4 is an exploded view of the different parts of the turbine;

FIG. 5 is a top plan view of the turbine and the wind flow outside and inside of the turbine, here we see how the wind interacts with the inner turbine and outer turbine; and

FIG. 6 is a top plan view of the angle the vanes have with respect to the radius of the turbine for optimal performance.

For purposes of clarity and brevity, like elements and components will bear the same designations and numbering throughout the Figures.

### DESCRIPTION OF THE PREFERRED EMBODIMENT

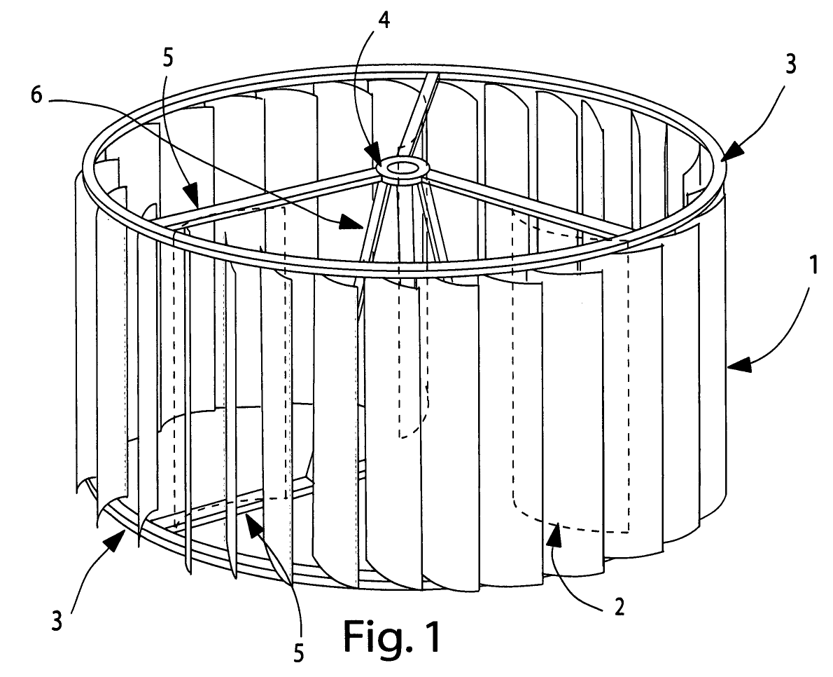

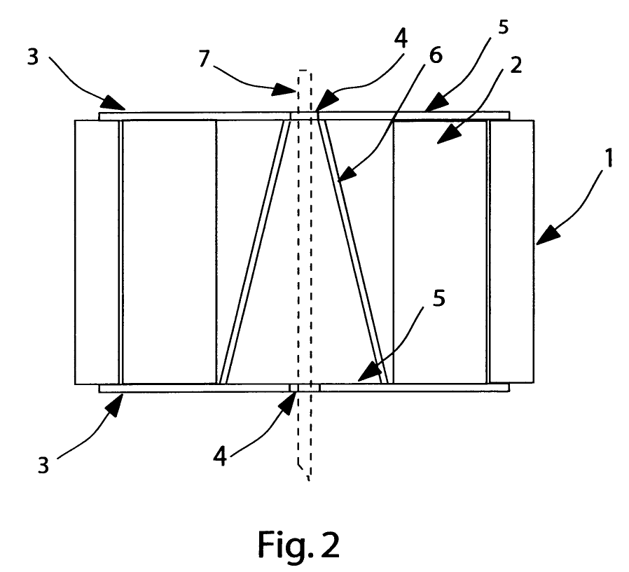

The turbine is of cylindrical shape, as shown in FIG. 1. It has two ring 3 one upper and another at the bottom. The ring 3 are connected to a upper central hub 4 (another central hub 4 at the bottom) by three spoke 5, there can be more spoke 5 depending on the strength to weight ratio. The central hub 4 is where the axle 7 as shown on FIG. 2, will run through the turbine. This axle 7 is where the turbine will rotate and will connect to a generator.

Stud 6 is connected to the top central hub 4 and to the lower spoke 5 at an angle to form a triangle with the lower spoke 5. The other two angle studs, as shown in FIG. 1 and FIG. 2 will form similar triangles with the other two spoke 5. The purpose of this triangle is to give structure strength to the turbine. There can more than three angled studs depending on the design.

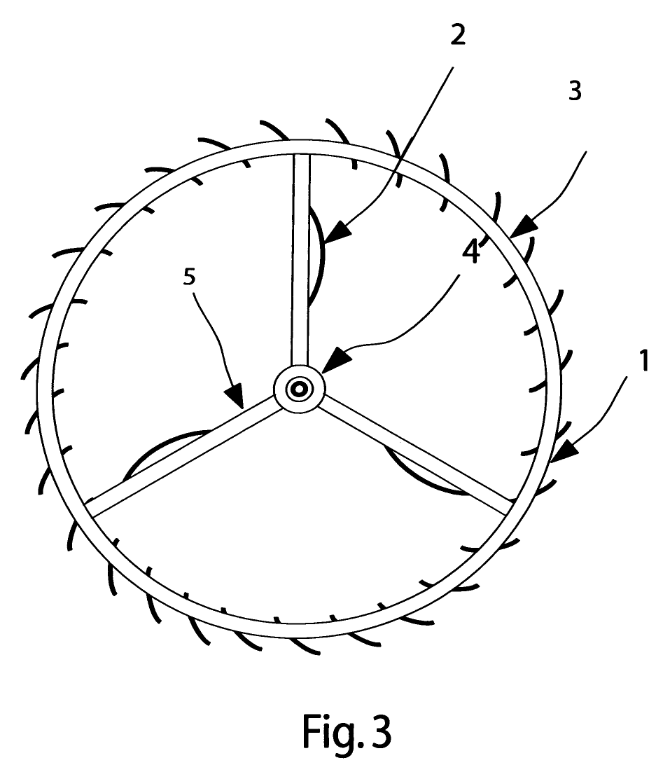

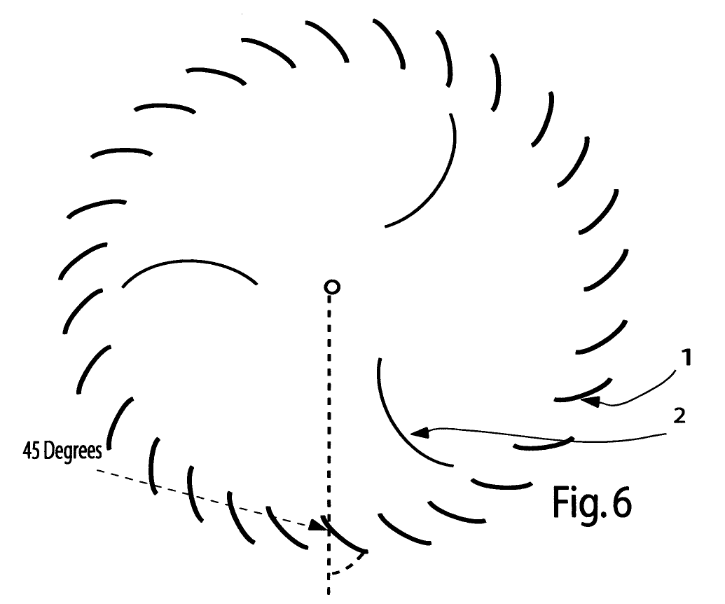

The turbine is compose of two turbines, the outer turbine 1 composed of 28 vertical vanes, the number of which depends on the size and design. There is also the inner turbine 2 compose of three vertical concave vanes but could have more vanes again depending on the design, as shown in FIG. 1, FIG. 2, FIG. 3 and FIG. 6.

FIG. 6 shows the inner turbine 2 and the outer turbine 1 that compose the main body of the turbine. The outer turbine 1 should have the vanes angled at 45 degrees with respect to the radius of the turbine for maximum efficiency.

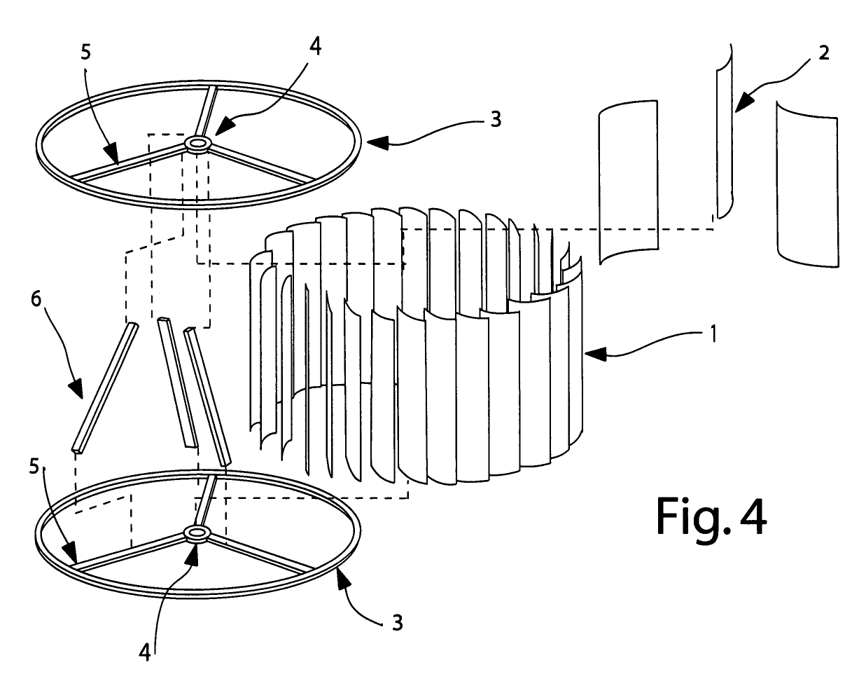

This turbine is different from others in that outer turbine 1 is not stationary but moves with the router and functions both as a shield and a rotating turbine. This action increases the overall torque of the turbine. FIG. 4 is an exploited view of the whole turbine, here we see how the inner turbine 2 will fit into the outer turbine 1 all been held together by the upper and lower ring 3.

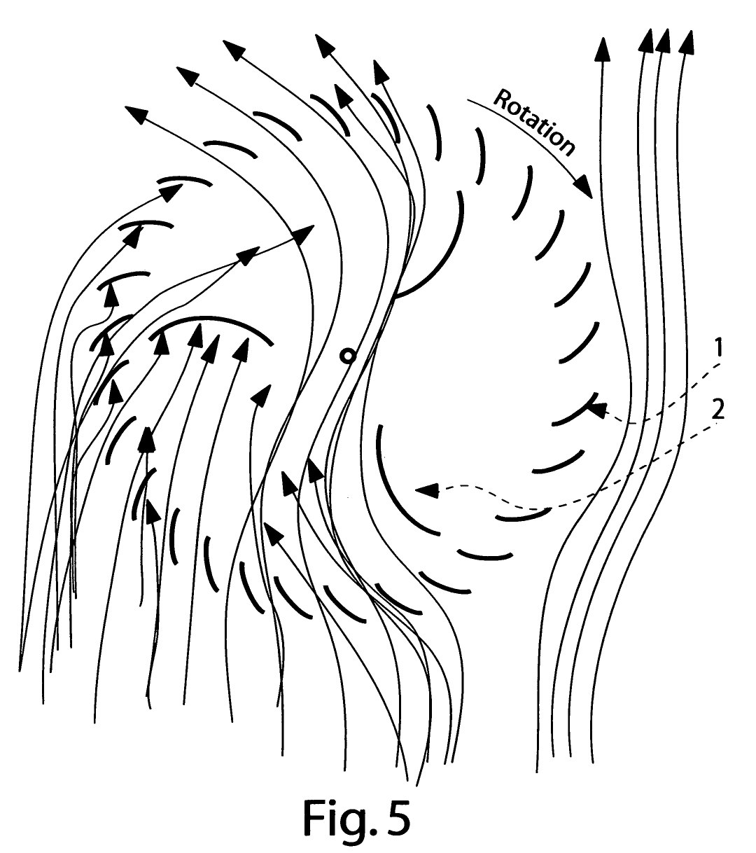

FIG. 5 shows the flow of wind through the turbine and how it interacts with outer turbine 1 and inner turbine 2. Here we see how the outer turbine 1 functions as a shield for the inner turbine 2. When inner turbine 2 is turning into the wind on the right side it is being shield by outer turbine 1 because of the overlapping effect of its vanes on the right side. On the left side the vanes are open to let the wind pass to the inner turbine 2 and push the inner turbine 2 on the convex side of the vanes. Also the outer turbine 1 is being push on the far left side because the vanes are open outward. This is so, because of the 45 degrees that the vanes of the outer turbine 1 have with respect to the diameter of the turbine. The interaction of outer turbine 1 and inner turbine 2 will cause a rotation in the same direction.

When the wind goes through the main turbine and exits the main turbine it will also cause a rotation that adds to the rotation of outer turbine 1 and inner turbine 2. Also the wind that do's not enter the turbine on the right side, will cause a suction effect for the wind that entered the turbine on the left side.

FIG. 5 is a representation of how the wind will interact with both the inner turbine 2 and the outer turbine 1 that compose the main structure.

This interaction of outer turbine 1 and inner turbine 2 will cause a grater torque at low wind speeds and when the turbine is moving a high load.

This turbine can operate at low level, on top of building or on top of a house because it is unidirectional and it is immune to wind turbulence. It will rotate in the same direction no matter if the wind comes from the top, bottom or in any of the 360 degrees around the turbine. All vanes on this turbine are concave so the vanes have more structural strength.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A double wind turbine for an “omni-directional vertical axle wind turbine” or vawt type with the purpose to do work using the wind as the primary input, comprising:
means for an outer turbine composed of vertical vanes;
means for a second inner turbine giving the turbine more efficiency;
means for connecting the whole structure to the axle;
means for connecting the axle to the ring;
means for giving the turbine structural strength, when used at an angle;
means for holding the whole structure together; and
means for connecting the turbine to the generator and where the turbine will rotate.

2. The double wind turbine in accordance with claim 1, wherein said means for an outer turbine composed of vertical vanes comprises an outer turbine.

3. The double wind turbine in accordance with claim 1, wherein said means for a second inner turbine giving the turbine more efficiency comprises an inner turbine.

4. The double wind turbine in accordance with claim 1, wherein said means for connecting the whole structure to the axle comprises a central hub.

5. The double wind turbine in accordance with claim 1, wherein said means for connecting the axle to the ring comprises a spoke.

6. The double wind turbine in accordance with claim 1, wherein said means for giving the turbine structural strength, when used at an angle comprises a stud.

7. The double wind turbine in accordance with claim 1, wherein said means for holding the whole structure together comprises a ring.

8. The double wind turbine in accordance with claim 1, wherein said means for connecting the turbine to the generator and where the turbine will rotate comprises an axle.

9. A double wind turbine for an “omni-directional vertical axle wind turbine” or vawt type with the purpose to do work using the wind as the primary input, comprising:
an outer turbine, for an outer turbine composed of vertical vanes;
an inner turbine, for a second inner turbine giving the turbine more efficiency;
a central hub, for connecting the whole structure to the axle;
a spoke, for connecting the axle to the ring;
a stud, for giving the turbine structural strength, when used at an angle;
a ring, for holding the whole structure together; and
an axle, for connecting the turbine to the generator and where the turbine will rotate.

10. A double wind turbine for an “omni-directional vertical axle wind turbine” or vawt type with the purpose to do work using the wind as the primary input, comprising:
an outer turbine, for an outer turbine composed of vertical vanes;
an inner turbine, for a second inner turbine giving the turbine more efficiency;
a central hub, for connecting the whole structure to the axle;
a spoke, for connecting the axle to the ring;
a stud, for giving the turbine structural strength, when used at an angle;
a ring, for holding the whole structure together; and
an axle, for connecting the turbine to the generator and where the turbine will rotate.
